(19) United States
(12) Patent Application Publication
(10) Pub. No.: US 2012/0270425 A1
(43) Pub. Date: Oct. 25, 2012

(54) METALLIC BOSS

(75) Inventors: Robert D. Rae, New Lenox, IL (US); Marius G. Enescu, Montgomery, IL (US)

(73) Assignee: Caterpillar Inc., Peoria, IL (US)

(21) Appl. No.: 13/542,969

(22) Filed: Jul. 6, 2012

Related U.S. Application Data
(63) Continuation of application No. 11/809,887, filed on May 31, 2007, now Pat. No. 8,238,253.
(60) Provisional application No. 60/839,333, filed on Aug. 22, 2006.
(60) Provisional application No. 60/897,543, filed on Jan. 26, 2007.
(60) Provisional application No. 60/905,624, filed on Mar. 7, 2007.
(60) Provisional application No. 60/922,246, filed on Apr. 5, 2007.

(51) Int. Cl. H01R 4/66; B22F 7/02

(52) U.S. Cl. 439/92; 419/7

(57) ABSTRACT

A bi-metallic boss is provided. The bi-metallic boss includes a first portion and a second portion. The first portion is made of a first metal powder. The second portion is integrated with the first portion. Moreover, the second portion made of a second metal powder, such that the second metal powder is different from the first metal powder.

### TECHNICAL FIELD

The present disclosure relates to an electrical grounding component and more specifically to a ground metallic boss.

### BACKGROUND

Ground bosses having a stainless steel plate welded atop the ground boss are known to be used in a variety of applications. For example, U.S. Pat. No. 4,934,952 relates to a bonding and electrical grounding assembly for interconnecting dissimilar metallic components. The assembly includes a flexible first metal strap and a first metal lug for mechanical fastening to a boss. The bosses are each bimetallic, such that the two dissimilar metals of each boss are directly bonded together by explosive cladding, roll-bonding, friction welding or any process which renders the bimetallic interface impervious to corrosion.

### SUMMARY OF THE DISCLOSURE

In one aspect of the present disclosure a bi-metallic boss is provided. The bi-metallic boss includes a first portion and a second portion. The first portion is made of a first metal powder. The second portion is integrated with the first portion. Moreover, the second portion made of a second metal powder, such that the second metal powder is different from the first metal powder.

In another aspect, a method for manufacturing a bi-metallic boss is provided. The method provides a second metal powder corresponding to a second portion of a bi-metallic boss. Also, the method provides a first metal powder corresponding to a first portion of the bi-metallic boss. The first metal powder is layered over the second metal powder. The first metal powder is different from the second metal powder. Further, the method heats the first and second metal powders to a pre-determined temperature to form the bi-metallic boss.

Other features and aspects of this disclosure will be apparent from the following description and the accompanying drawings.

### BRIEF DESCRIPTION OF THE DRAWINGS

FIG. 1 is a diagrammatic view of an exemplary bi-metallic boss, according to one aspect of the present disclosure;

FIG. 2 is a top view of the bi-metallic boss shown in FIG. 1;

FIG. 3 is a cross sectional view of the bi-metallic boss shown in FIG. 1; and

FIG. 4 is a process for manufacturing the bi-metallic boss.

### DETAILED DESCRIPTION

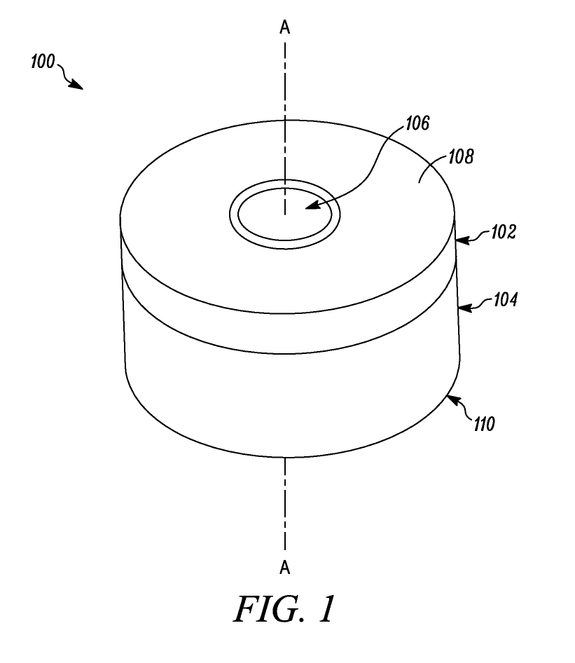

FIG. 1 illustrates a diagrammatic view of an exemplary bi-metallic boss 100, according to one embodiment of the present disclosure. The bi-metallic boss 100 may include a first portion 102 and a second portion 104. The first portion 102 may be made of a first metal powder. In one embodiment, the first metal powder may include powdered stainless steel. A person of ordinary skill in the art will appreciate that the powdered stainless steel used to make the first portion 102 may belong to the 300 series. Moreover, as shown in the accompanied figures, the second portion 104 may be integrated with the first portion 102. The second portion 104 may be made of a second metal powder, such that the second metal powder is different from the first metal powder. In another embodiment, the second metal powder may include powdered carbon steel. One of ordinary skill in the art will appreciate that the minimum yield strength for the second portion 104 may be 18,000 psi or 124 MPa.

As shown in FIG. 1, the bi-metallic boss 100 may have a cylindrical shape. Further, the bi-metallic boss 100 may include a central cavity 106 along a longitudinal axis AA. The central cavity 106 may be configured to receive a bolt. Moreover, an inner surface 302 (see FIG. 3) of the bi-metallic boss 100 may include threads (not shown in the figures) configured to mate with corresponding threads on the bolt. In one embodiment, a washer may be provided beneath a head of the bolt. The washer may be configured to fasten the bolt within the central cavity 106 of the bi-metallic boss 100.

Referring to FIG. 1, the first portion 102 of the bi-metallic boss 100 may include a top face 108. In one embodiment, the top face 108 may be configured to mount a ground strap. A person of ordinary skill in the art will appreciate that the top face 108 made of powdered stainless steel may be less likely to rust at the ground strap and bi-metallic boss interface. In another embodiment, the top face 108 may be in contact with a metallic lug. It should be understood that the metallic lug may be fastened to the top face 108 of the bi-metallic boss 100 by the bolt threaded into the central cavity 106.

Moreover, a bottom face 110 of the second portion 104 may be configured to be welded to any surface. For example, the bi-metallic boss 100 may be utilized in various locations on any construction machine. It should be noted that the welding may be performed by known methods. Additionally, since the second portion 104 of the bi-metallic boss 100 is made of powdered carbon steel, a standard mild steel wire rod may be used to weld the bottom face 110 to the welding surface.

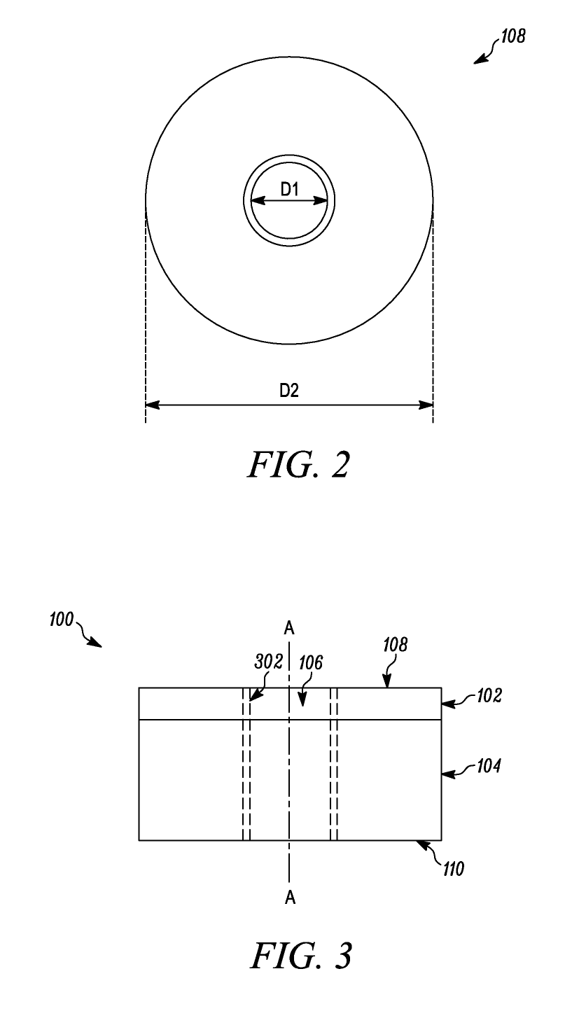

FIGS. 2 and 3 illustrate top and cross sectional views of the bi-metallic boss 100 respectively. It should be noted that an inner diameter D1, an outer diameter D2, length, and thickness of the bi-metallic boss 100 may vary without any limitation. Referring to FIG. 3, a thickness of the first portion 102 may be relatively lesser than a thickness of the second portion 104. For example, the thickness of the first portion 102 may lie approximately between about 1 mm to 1.5 mm and the thickness of the second portion 104 may be approximately between 4 mm and 6 mm. In another example, the thickness of the first portion 102 may be approximately about 1 mm at the minimum, whereas the thickness of the second portion may be approximately about 10 mm at the minimum. In yet another embodiment the thickness of the first portion is between 0.5 mm and 2.5 mm and the thickness of the section portion is between 4 mm and 20 mm.

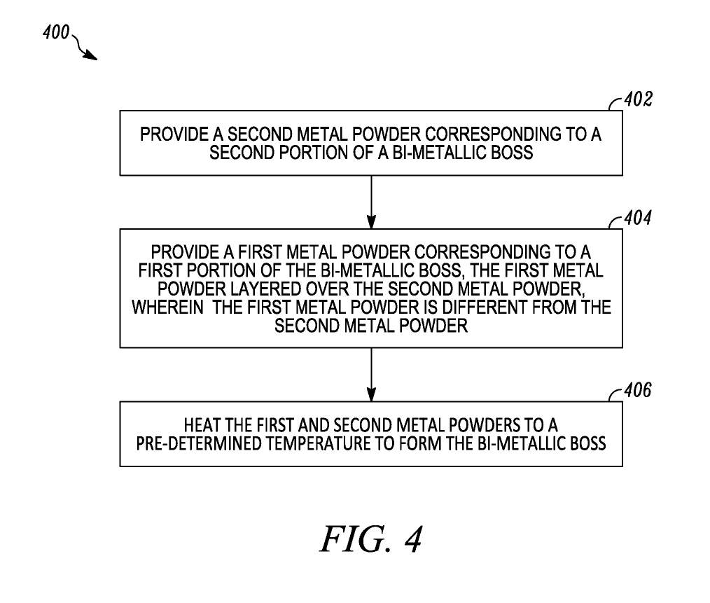

A person of ordinary skill in the art will appreciate that the first and second portions 102, 104 of the bi-metallic boss 100 may be considered as a single consolidated or integrated structure. Hence, the use of any external joining process such as, for example, welding, may be eliminated. An exemplary process 400 of manufacturing the bi-metallic boss 100 will be described in connection with FIG. 4.

### INDUSTRIAL APPLICABILITY

Typically, ground bosses are made of carbon steel such that a stainless steel plate is welded onto the ground boss. Currently used welding rods are especially made for mild steel welding. Different type of wire rods need to be used for stainless steel welding. To this end, the welding rods may need to be changed in order to weld the stainless steel plate onto the ground boss. A change in set up for special stainless steel welding can drive significant time and cost to the process. This may primarily be attributed to the fact that using a carbon steel rod for welding a stainless steel plate may result in poor adherence between the stainless steel plate and the ground boss.

As stated above, changing of the welding rods may be a time consuming and inconvenient activity. Hence, in order to avoid changing the welding rods, one possible solution may include having a boss made of carbon steel. However, such bosses may rust easily, resulting in loss of electrical contact.

The present disclosure provides the bi-metallic boss 100 having the first and second portions 102, 104 made of dissimilar metals integrated with each other. It should be understood that since the first and second portions 102, 104 of the bi-metallic boss 100 are integrated, the previously used welding operation for joining the stainless steel plate may be eliminated. Additionally, since the bi-metallic boss 100 may include a relatively larger quantity of carbon steel as compared to that of stainless steel, the cost of production of the bi-metallic boss 100 is low. Further, the use of a special welding rod may be avoided with this design.

In step 402, the second metal powder corresponding to the second portion 104 of the bi-metallic boss 100 may be provided. In step 404, the first metal powder corresponding to the first portion 102 of the bi-metallic boss 100 may be provided. More specifically, the first metal powder may be layered over the second metal powder. Also, the first metal powder may be different from the second metal powder. In one embodiment, the first metal powder may include powdered stainless steel, whereas the second metal powder may include powdered carbon steel.

Thereafter, at step 406, the first and second metal powders may be heated to a pre-determined temperature to form the bi-metallic boss 100. The heating may cause consolidation of the first and second metal powders. Typically, the pre-determined temperature may be the minimum re-crystallization temperature of the first and second metal powders. It should be understood that the first and second metal powders may be placed in molds or any other similar structure known in the art to hold and shape the metal powders. In one embodiment, the central cavity 106 and/or cylindrical shape of the bi-metallic boss 100 may be provided using any suitable cutting method known in the art. Further, the inner diameter D1 of the bi-metallic boss 100 may vary according to the application. In one embodiment, the threads may be provided on the inner surface 302 of the bi-metallic boss 100 in order to mate with the corresponding threads on the bolt.

It should be noted that the method of manufacturing the bi-metallic boss 100 described herein is on an exemplary basis and does not limit the scope of the present disclosure. A person of ordinary skill in the art will appreciate that the shape, size and other related parameters of the bi-metallic boss 100 may vary based on the application. Also, the bi-metallic boss 100 may be welded to a variety of flat or curved surfaces without any limitation. Further, one of ordinary skill in the art will appreciate that the term “made of metal powder” used herein does not restrict the scope of this disclosure to merely the formation of the bi-metallic boss 100 according to the method 400. Even after formation of the bi-metallic boss 100, if the bi-metallic boss 100 is re-heated, the re-heated metal may still be considered to be “made of metal powder”.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A bi-metallic boss comprising:
a first portion made of a first metal powder; and
a second portion integrated with the first portion, the second portion made of a second metal powder, wherein the second metal powder is different from the first metal powder.

2. The bi-metallic boss of claim 1, wherein the first metal powder includes powdered stainless steel.

3. The bi-metallic boss of claim 1, wherein the second metal powder includes powdered carbon steel.

4. The bi-metallic boss of claim 1, wherein the first portion is configured to mount a ground strap.

5. The bi-metallic boss of claim 1, wherein the bi-metallic boss has a cylindrical shape.

6. The bi-metallic boss of claim 1 further including a central cavity, wherein an inner surface of the bi-metallic boss includes threads configured to mate with corresponding threads on a bolt.

7. The bi-metallic boss of claim 2, wherein the second portion is configured to be welded using a standard mild steel wire rod.

8. The bi-metallic boss of claim 1, wherein the first portion has a thickness between 0.5 mm and 2.5 mm.

9. The bi-metallic boss of claim 1, wherein the first portion has a thickness between 1 mm and 1.5 mm.

10. The bi-metallic boss of claim 9, wherein the second portion has a thickness between 4 mm and 6 mm.

11. The bi-metallic boss of claim 1, wherein the first metal powder is a 300 series stainless steel.

12. A method comprising:
providing a second metal powder corresponding to a second portion of a bi-metallic boss;
providing a first metal powder corresponding to a first portion of the bi-metallic boss, the first metal powder layered over the second metal powder, wherein the first metal powder is different from the second metal powder; and
heating the first and second metal powders to a pre-determined temperature to form the bi-metallic boss.

13. The method of claim 12, wherein the first metal powder includes powdered stainless steel.

14. The method of claim 12, wherein the second metal powder includes powdered carbon steel.

15. The method of claim 12 further including providing threads on an inner surface of the bi-metallic boss, the threads configured to mate with corresponding threads on a bolt.

16. The method of claim 12 wherein the first metal powder is a 300 series stainless steel.
